(19) United States
(12) Patent Application Publication
(10) Pub. No.: US 2013/0296003 A1
(43) Pub. Date: Nov. 7, 2013

(54) MULTI-HANDSET CORDLESS TELEPHONE SYSTEM WITH POWER BACKUP FUNCTION

(71) Applicant: Cheng-Fu Lin, New Taipei Hsien (TW)

(72) Inventor: Cheng-Fu Lin, New Taipei Hsien (TW)

(21) Appl. No.: 13/463,818

(22) Filed: May 4, 2012

(51) Int. Cl. H04W 52/00

(52) U.S. Cl. 455/573

(57) ABSTRACT

A multi-handset cordless telephone system with power backup function causes that the power stored in the handsets can be reused as a power supply of the base unit in power outage state so that the power supply to the base unit is uninterrupted. Furthermore, the rechargeable backup cell added to the circuit further causes that the power is indeed uninterrupted even at the initial timing of the power outage. Moreover, broadcasting to the handsets wirelessly or through networks cause the users to keep attention to the power outage state as it occurs so as to adapt required operations for continuation of communication. However the present invention is suitable for usages of hospitals, hotels, and those having a large amount of handsets distributed in wide areas. These applications need to assure the un-interruption of communication.

### FIELD OF THE INVENTION

This invention relates generally to wireless communications, and in particular to a multi-handset cordless telephone system with power backup function.

### BACKGROUND OF THE INVENTION

Cordless remote telephones are popular consumer devices which allow a user in a home or office the freedom to stray hundreds or even thousands of feet from a base unit. With the advancement in technology of cordless telephones, processors such as digital signal processors or microprocessors have been included within the base unit and/or the handset of a cordless telephone. The processors provide the cordless telephone with a vast array of features, but require a power source to operate.

In wireless telephone systems, one or more cordless or wireless telephone handset units communicate via either analog or digital radio signals with a base unit, which is typically connected via a standard telephone line to an external telephone network. In this manner, a user may employ the wireless handset to engage in a telephone call with another user through the base unit and the telephone network.

Multi-line wireless telephone systems are also in use in various situations, such as businesses with many telephone users. Such systems employ a handset that communicates with up to N handsets simultaneously, typically with digital communications schemes, a single RF channel is used, and each handset transmits and receives data with a base unit. Efficient power use is important for a wireless system since the handsets are typically battery-powered. The base unit typically requires more power to operate than the handsets, and is thus usually powered by an external power supply. Irregularities may occur in the power, such as a loss of power or momentary power spikes or glitches, which can cause communications to be disrupted.

However, the radio telephone system requires a specific power in order to perform the communication between the wireless handset and the main body. Accordingly, in the conventional radio telephone system, in case the power is not supplied to the main body due to the power failure or the like, the communication between the main body and the wireless handset is impossible, and thus the radio communication cannot be carried out.

Therefore, there is an eager demand for a novel one which can improve above mentioned defects.

### SUMMARY OF THE INVENTION

Accordingly, for improving the above mentioned prior art defects, the present invention provides a multi-handset cordless telephone system with power backup function which provide an uninterrupted power supply to a cordless telephone system by the power supply from the handsets. Furthermore, a rechargeable backup cell is added to the circuit of the base unit so as to provide power as the short interval when the power initially failed. The present invention also provides a broadcasting function to broadcast to other users for keeping attention as power failure occurs and thus to place the handset to the cradle of the base unit.

To achieve above object, the present invention provides a multi-handset cordless telephone system with power backup function; comprising: one or more handsets; each of the handsets including a rechargeable battery and a charge terminal that are electrically coupled with the battery; a base unit capable of wirelessly communicating with any handset; the base unit receiving power from a power line which is connected to an external power source; the base unit including a cradle which includes charge contact set and is configured to receive one of handsets for supporting the handset and facilitating provision of power to recharge the battery of the handset stationed within cradle; and wherein during normal operation, the battery of the handset is recharged via the charge contact set; the configure of the charge contact set is able to be coupled to the charge terminal of each handset when one of the handsets is placed within cradle of base unit; and wherein the handset is placed on the cradle by the upper side thereof lying upon the cradle, or by the bottom side thereof lying upon the cradle, while the power conveyance from the handset to the base unit is not affected.

Furthermore, the present invention further provides a rechargeable backup cell; under the power outage mode the power stored in the rechargeable backup cell can retain the operation of the base unit for a predetermined time period; at this state, a broadcasting unit will broadcast all the handsets and all preset network connections so that users will keep attention and to adapt required actions.

### BRIEF DESCRIPTION OF THE DRAWINGS

FIG. 1 is a schematic diagram of an exemplary cordless telephone system that includes a plurality of handsets.

FIG. 2 is a schematic block diagram showing the cordless telephone system of the present invention.

FIG. 3 is a schematic block diagram showing another cordless telephone system according to the present invention.

FIG. 4 is a schematic block diagram showing a further cordless telephone system according to the present invention.

FIG. 5-1 shows a first structure about the arrangement of contact points according to the present invention.

FIG. 5-2 shows a second structure about the arrangement of the contact points according to the present invention.

### DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The drawings describe a wireless communication system including an external powered base unit 200 and at least one battery charged handset 300. The base unit is capable of operation in the event of a power failure.

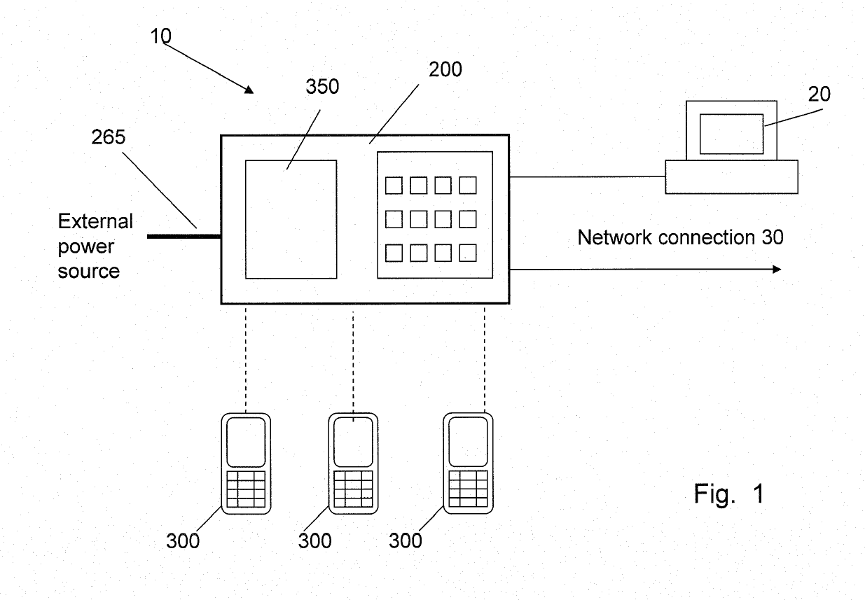

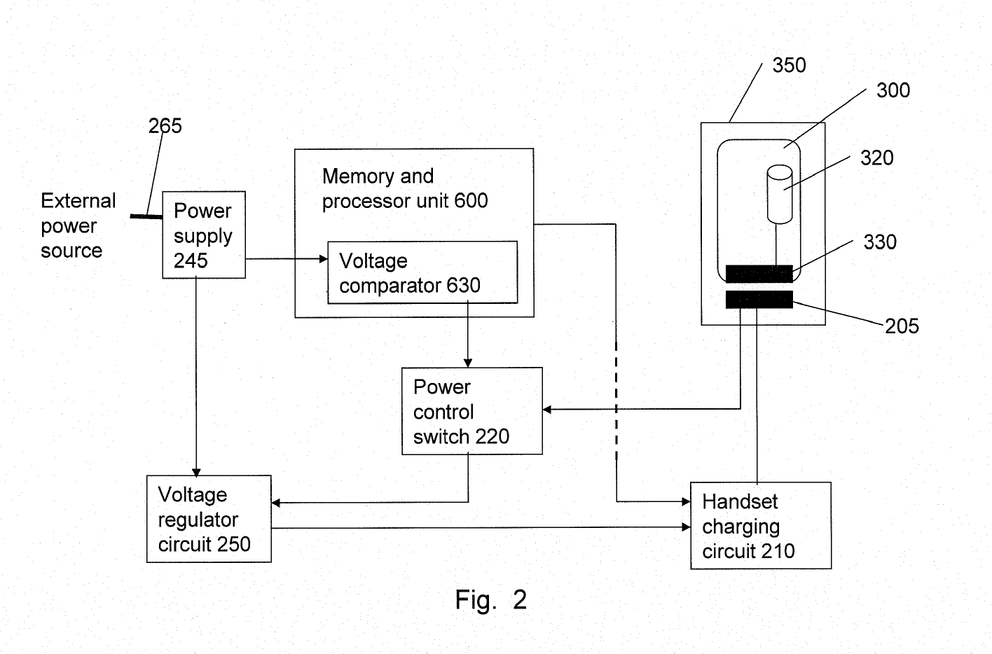

FIG. 1 shows a multi-handset cordless telephone system 10 of the present invention. The cordless telephone system 10 includes a base unit 200 and one or more handsets 300. The handsets 300 are wirelessly communicated with external communication units through the base unit 200. FIG. 2 is a schematic block diagram of the base unit 200 having the handset 300 positioned within cradle 350.

Each of the handsets 300 includes a rechargeable battery 320 (as shown in FIG. 2). Each handset has a charge terminal 330 that are electrically coupled with the battery 320.

The base unit 200 is capable of wirelessly communicating with any handset 300. The base unit 200 can further act as a wireless gateway by providing a wireless data link with other digital devices including personal computer 20, etc. Furthermore, the base unit 200 can also connect with other electronic device through a network connection 30. The base unit 200 receives power from a power line 265, which is connected to an external power source.

The base unit 200 includes a cradle 350 which includes a charge contact set 205 and is configured to receive one of handsets 300 for supporting the handset 300 and facilitating the provision of power to recharge the battery 320 of the handset 300 stationed within cradle 350. During a normal operation, the battery 320 of the handset 300 is recharged via the charge contact set 205. The configure of the charge contact set 205 is able to be coupled to the charge terminal 330 of each handset when one of the handsets 300 is placed within cradle 350 of base unit 200 (as schematically depicted in FIG. 2).

In an alternative embodiment, each of handsets is placed within a separate charging cradle that is electrically connected to a power outlet. The base unit 200 may also include a speakerphone (not shown) that allows a user to receive and place telephone calls without using any of the handsets. The speakerphone preferably includes a microphone and a speaker.

FIG. 2 shows that the base unit further comprises the following circuit components:

A power supply 245 receives the power from the power line 265 and conveys power to the devices in the next stages.

A voltage regulator circuit 250 serves to receive power and to distribute power to other element of the cordless phone. The voltage regulator circuit 250 receive an external control signal to determine the power conveyance.

A memory and processor unit 600 serves to perform all the logic functions of the present invention and stores the related data used in the present invention. The memory and processor unit 600 includes a voltage comparator 630.

A handset charging circuit 210 conveys power received from the regulators 250 to the charge contact set 205 and, in turn, to the handset battery 320 via charge terminal 330. Accordingly, the handset battery 320 is recharged.

In operation, the voltage comparator 630 in the memory and processor unit 600 serves to compare a voltage level of the base power supply 245 with a predefined threshold operation level stored in the memory and processor unit 600. When the power supply voltage exceeds the threshold level, a power outage condition is deemed not presented and the phone is defined to be operated in a normal operation mode. Therefore, the voltage comparator 630 will send a signal to the voltage regulator circuit 250 to cause the voltage regulator circuit 250 to convey power to the handset charging circuit 210. Therefore, the handset charging circuit 210 is activated. The handset charging circuit 210 conveys power received from the regulators 250 to the charge contact set 205 and, in turn, to the handset battery 320 via charge terminal 330. Accordingly, the handset battery 320 is recharged. However, when the voltage comparator 630 determines that the voltage level of the base power supply 245 is lower than the predefined threshold operation level. It deems that the phone is operated in a power outage mode and thus it will conduct the power to flow from the batter 320 to the base unit 200.

In normal operation mode, the power supply 245 receives the power from the power line 265 and conveys power to the voltage regulator circuit 250 and the voltage comparator 630 in a memory and processor unit 600. The voltage regulator circuit 250 serves to distribute the regulated power to the circuitry within the base unit 200, including handset charging circuit 210.

Furthermore, as above mentioned, the present invention provides the function of power backup to the base unit 200 by using the power in the handset 300. Thereby, the system of the present invention further comprises a power control switch 220 which responds to the power outage operation mode derived from the voltage comparator 630. The charge contact set 205 being connected to the power control switch 220 and then to the voltage regulators 250. The regulator 250 then draws power from handset battery 320 through contact set 205 and the power control switch 220 as power outage occurs. Meanwhile the handset charging circuit 210 is closed to prevent power flowing from the voltage regulator circuit 250 to the handset.

In this way, the base unit 200 remain available during the failure of power line 265 by drawing power from the battery of a handset disposed within the base cradle. Thus, telephone calls can be conducted using any of the handsets 300. When the battery 320 within the handset 300 becomes depleted, the handset 300 can be replaced by placing another handset 300 within the base unit cradle, such that further continued operation is available. Such use can be continued so long as handsets having battery power remain available.

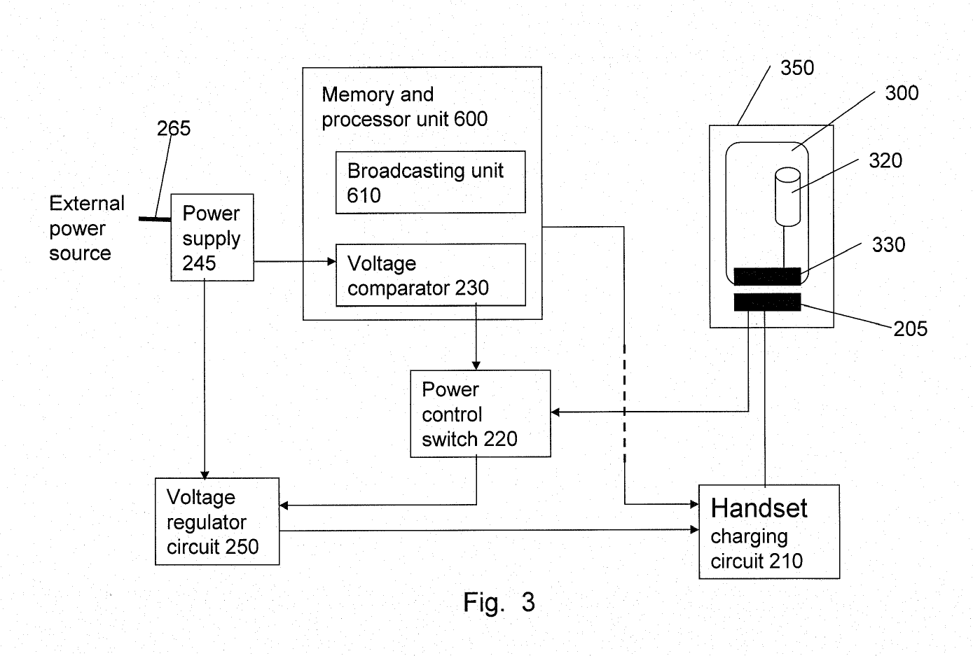

Moreover, as illustrated in FIG. 3, the present invention provides system managing function to the cordless phone by the microprocessor 600 further including the following function units.

A broadcasting unit 610 serves to broadcast messages about the operation states to all the handsets. Especially, in power outage mode, the broadcasting unit 610 can broadcast the state to all the handsets so that the users of the handset will keep attention to the state. As result, by the functions provided by the present invention, the loss of phone call will reduce to a minimum value.

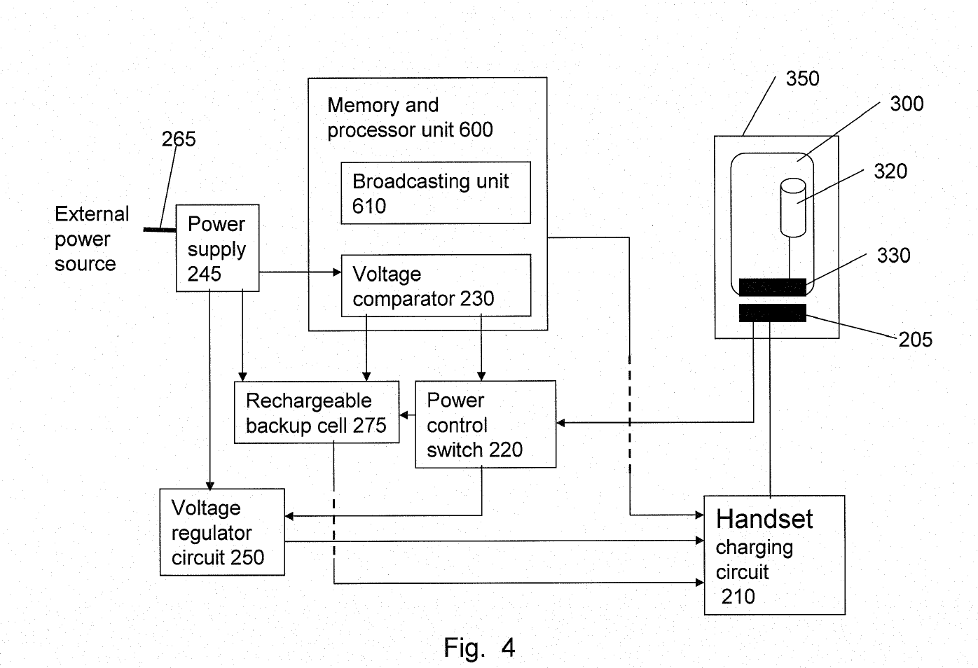

FIG. 4 is a schematic block diagram of the base unit 200, in that a rechargeable backup cell 275 is include therein. In this embodiment, the present invention can be further added with a rechargeable backup cell 275 which is connected to the base power supply 245 for receiving power therefrom. The rechargeable backup cell 275 receives control signals from the voltage comparator circuit 630 under the power outage mode. The control signal will turn on the rechargeable backup battery cell 275 under the power outage mode so that the power will convey to the voltage regulator circuit 250 for further supplying to other element of the circuit. Therefore the communication of the base unit can be retained for a predetermined time period. However, at this state, the broadcasting unit 610 will broadcast all the handsets and all set network connections so that users will keep attention and to adapt required actions, such as to place one handset to the cradle or to startup a backup power source, or repair the power supply device, etc.

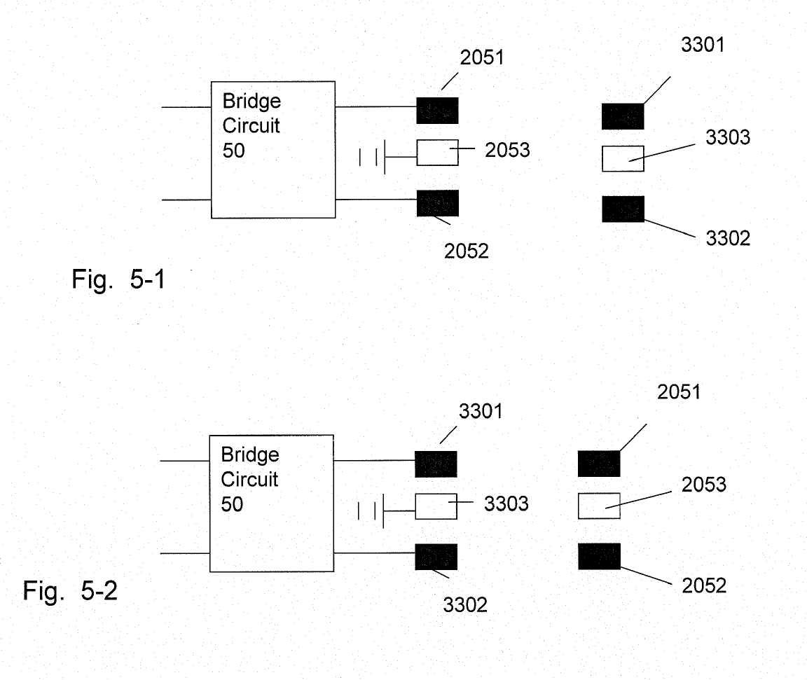

Referring to FIGS. 5-1 and 5-2, it shows the design about the charge contact set 205 of the present invention. In the present invention, the charge contact set 205 of the base unit 200 includes three contact points and the charge terminal 330 of each handset 300 also includes three contact points. In FIG. 5-1, the charge contact set 205 has three contact points 2051, 2052, 2053, in that the contact points 2051, 2052 are data and power transferring points and the contact points 2053 is a grounding point. The two contact points are connected to a bridge circuit 50 and the contact points are arranged at lateral side of the handset with the contact set of the base unit has a corresponding arrangement so that as the handset 310 is rotated through 180 degrees (upside down), the operation of power conveyance from the handset to the base unit is still affected. However as illustrated in FIG. 5-2, the bridge circuit 50 can be installed in the charge terminal sides with the contact points 3301, 3302 and 3303. It still has the same effect. Therefore, by above mentioned arrangement, the handset 310 can be placed on the cradle 350 by the upper side thereof lying upon the cradle 350, or by the bottom side thereof lying upon the cradle 350, while the power transformation is not affected.

The configure of the charge contact set 205 is able to be coupled to the charge terminal 330 of each handset 300 when one of the handsets is placed within cradle 350 of base unit 200 (as schematically depicted in FIG. 2).

Advantages of the present invention are that: the present invention causes the power stored in the handsets can be reused as a power supply of the base unit in power outage state so that the power supply to the base unit is uninterrupted. Furthermore, the rechargeable backup cell added to the circuit further causes that the power is indeed uninterrupted even at the initial timing of the power outage. Moreover, broadcasting to the handsets wirelessly or through networks cause the users to keep attention to the power outage state as it occurs so as to adapt required operations for continuation of communication. However the present invention is suitable for usages of hospitals, hotels, and those having a large amount of handsets distributed in wide areas. These applications need to assure the un-interruption of communication.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-handset cordless telephone system with power backup function; comprising:
one or more handsets; each of the handsets including a rechargeable battery and a charge terminal that are electrically coupled with the battery;
a base unit capable of wirelessly communicating with any handset; the base unit receiving power from a power line which is connected to an external power source; the base unit including a cradle which includes charge contact set and is configured to receive one of handsets for supporting the handset and facilitating provision of power to recharge the battery of the handset stationed within cradle; and
wherein during normal operation, the battery of the handset is recharged via the charge contact set; the configure of the charge contact set is able to be coupled to the charge terminal of each handset when one of the handsets is placed within cradle of base unit; and
wherein the handset is placed on the cradle by the upper side thereof lying upon the cradle, or by the bottom side thereof lying upon the cradle, while the power conveyance from the handset to the base unit is not affected.

2. The multi-handset cordless telephone system with power backup function as claimed in claim 1, wherein the base unit further comprises:
a power supply receiving power from the power line;
a voltage regulator circuit receiving power from the power supply and distributing power to other element of the cordless phone; and the voltage regulator circuit receiving control signals to determine the power conveyance;
a memory and processor unit performing all the logic functions in the system and storing related data; the memory and processor unit including a voltage comparator for comparing voltage level from the handset charging unit; the voltage comparator serving to compare a voltage level of the base power supply with a predefined threshold operation level stored in the memory and processor unit so as to determine a normal operation mode and a power outage mode;
a handset charging circuit conveying power received from the regulators to the charge contact set and, in turn, to the handset battery via charge terminal;
a power control switch capable of responding the power outage operation mode from the voltage comparator, thereby the charge contact set being connected through the power control switch to the voltage regulator circuit; the voltage regulator circuit then drawing power from handset battery through contact set and the power control switch.

3. The multi-handset cordless telephone system with power backup function as claimed in claim 1, wherein the base unit can further act as a wireless gateway by providing a wireless data link with other digital devices or linking with other networks.

4. The multi-handset cordless telephone system with power backup function as claimed in claim 1, wherein the microprocessor further including a broadcasting unit for broadcasting messages about the operation states to all the handsets and connected devices through network.

5. The multi-handset cordless telephone system with power backup function as claimed in claim 2, wherein the charge contact set of the base unit includes three contact points and the charge terminal of each handset also includes three contact points; two data and power transferring points of the charge contact set are connected to a bridge circuit so that as the handset is upside down, the operation of power conveyance is still effected.

6. The multi-handset cordless telephone system with power backup function as claimed in claim 2, wherein the charge terminal of the handset includes three contact points and the charge contact set of each handset also includes three contact points; two data and power transferring points of the charge terminal are connected to a bridge circuit so that as the handset is upside down, the operation of power conveyance is still effected.

7. A multi-handset cordless telephone system with power backup function; comprising:
one or more handsets; each of the handsets including a rechargeable battery and a charge terminal that are electrically coupled with the battery;
a base unit capable of wirelessly communicating with any handset; the base unit receiving power from a power line which is connected to an external power source; the base unit including a cradle which includes charge contact set and is configured to receive one of handsets for supporting the handset and facilitating the provision of power to recharge the battery of the handset stationed within cradle; and
a rechargeable backup cell; under the power outage mode the power stored in the rechargeable backup cell can retain the operation of the base unit for a predetermined time period; at this state, a broadcasting unit will broadcast all the handsets and all preset network connections so that users will keep attention and to adapt required actions;
wherein during normal operation, the battery of the handset is recharged via the charge contact set; the configure of the charge contact set is able to be coupled to the charge terminal of each handset when one of the handsets is placed within cradle of base unit; and
wherein the handset is placed on the cradle by the upper side thereof lying upon the cradle, or by the bottom side thereof lying upon the cradle, while the power transformation is not affected.

8. The multi-handset cordless telephone system with power backup function as claimed in claim 7, wherein the base unit further comprises:
a power supply receiving power from the power line;
a voltage regulator circuit receiving power and to distribute power to other element of the cordless phone; and the voltage regulator circuit receiving control signals to determine the power conveyance;
a memory and processor unit performing all the logic functions in the system and storing related data; the memory and processor unit including a voltage comparator and the broadcasting unit; the voltage comparator serving for comparing voltage level from the handset charging unit; the voltage comparator serving to compare a voltage level of the base power supply with a predefined threshold operation level stored in the memory and processor unit so as to determine a normal operation mode and a power outage mode;
a handset charging circuit conveying power received from the voltage regulator circuit to the charge contact set and, in turn, to the handset battery via the charge terminal.
a power control switch responding a power outage operation mode from the voltage comparator, the charge contact set being connected through the power control switch to the voltage regulator circuit; the voltage regulator circuit then drawing power from the handset battery through the contact set and the power control switch; and
the rechargeable backup cell connected to the base power supply for receiving power therefrom and storing the receiving power, the power control switch and the handset charging circuit; the cell power switch receiving control signals from the voltage comparator circuit under the power outage mode; the control signal will turn on the rechargeable backup battery cell under the power outage mode so that the power will convey to the voltage regulator circuit for further providing to other elements of the circuit; therefore the communication of the base unit can be retained for a predetermined time period; at this state, the broadcasting unit will broadcast all the handsets and all set network connections so that users will keep attention and to adapt required actions.

9. The multi-handset cordless telephone system with power backup function as claimed in claim 7, wherein the base unit can further act as a wireless gateway by providing a wireless data link with other digital devices or linking with other networks.

10. The multi-handset cordless telephone system with power backup function as claimed in claim 8, wherein the charge contact set of the base unit includes three contact points and the charge terminal of each handset also includes three contact points; two data and power transferring points of the charge contact set are connected to a bridge circuit so that as the handset is upside down, the operation of power conveyance is still effected.

11. The multi-handset cordless telephone system with power backup function as claimed in claim 8, wherein the charge terminal of the handset includes three contact points and the charge contact set of each handset also includes three contact points; two data and power transferring points of the charge terminal are connected to a bridge circuit so that as the handset is upside down, the operation of power conveyance is still effected.
